(19) United States
(12) Patent Application Publication
(10) Pub. No.: US 2009/0083637 A1
(43) Pub. Date: Mar. 26, 2009

(54) Method and System for Online Collaboration

(76) Inventors: Jens Skakkebaek, San Carlos, CA (US); Philipp M. Stauffer, Palo Alto, CA (US)

Correspondence Address: COURTNEY STANIFORD & GREGORY LLP, P.O. BOX 9686, SAN JOSE, CA, 95157, US

(21) Appl. No.: 12/206,723

(22) Filed: Sep. 8, 2008

Related U.S. Application Data
(60) Provisional application No. 60/970,918, filed on Sep. 7, 2007.

(51) Int. Cl. G06F 3/00

(52) U.S. Cl. 715/751

(57) ABSTRACT

Embodiments of a method and system for online collaboration enable multiple users to gather content electronic content items from various sources. The content items are associated with a particular user and with each other. Users can find other users that have similar content or personal information. A collaboration session is hosted between multiple participating users that allows the users to access and modify common content during the same session. Modification includes a user marking or labeling content with a label that includes metadata regarding the content. Information from the session, including modifications, is automatically processed and stored as result data. An example of result data is a flash card created for the purpose of language learning. The result data is accessible by the user later for further use and/or modification.

### RELATED APPLICATIONS

This application claims the benefit of U.S. Provisional Patent Application No. 60/970,918, filed Sep. 7, 2007, which is hereby incorporated by reference in its entirety.

### FIELD OF THE INVENTION

Embodiments described herein relate generally to online collaboration systems.

### BACKGROUND

The ability to collaborate is an age old, fundamental activity for humans and necessary for continued progress and learning. With all participants present at the same geographical location, it is easy for participants to share objects and content, discuss, create new content and learning, and use this newly generated content for continued learning after the collaboration session has ended. As an example, students and teachers can get together and learn a new language by looking at text, pictures, and videos and discuss. During the session, the participants can create flash cards of new words related to the content. The student can then save these flash cards for later use, and practice the language skills by memorizing the new phrases written on the flash card. As another example, doctors looking at x-ray pictures can write or dictate notes and revisit these later for medical diagnosis or learning.

With phones and phone systems, collaboration between users in remote locations may currently take place via phone conferences. However, phone conferences have limitations. For example, participants cannot point at shared content or receive visual clues. Collaborative use and of creation of various types of content is not really possible during a phone session.

With the advent of the Internet, it is now easy to conduct collaboration sessions, using both audio and video. Examples of such systems are WebEx™ and GotoMeeting™. However, while these systems allow the participants to share and collaborate around previously generated content in electronic form, they do not support the ability to easily create new content derived from the collaboration session, save this newly created content in an a form and place accessible to the participants, or allow the participants to easily view, modify, and manage content after the collaboration session has ended. Referring to the language learning example above, it would be desirable to have a system that easily allows the manual, semi-manual or automated creation of flashcards or other outputs during a language learning collaboration session. It would be desirable to have system that allows flash cards to be saved and used later to practice, for example, language skills. Similarly, it would be desirable to have a system that easily allows to use generated content in entertainment like environments like games. Similarly, it would be desirable to have a system that easily allows doctors to collaborate around x-rays to easily generate notes, save them, and revisit them later.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a block diagram of a collaboration system according to an embodiment.

FIG. 2 is a diagram of a collaboration user interface screen according to an embodiment.

FIG. 3 is a diagram of a messaging exchange with associated devices and storage according to an embodiment.

FIG. 4 is a diagram illustrating an example of a label that can be generate during a language learning collaboration session according to an embodiment.

FIG. 5 is a diagram illustrating an example of a content creation message that is used to communicate between devices during a collaboration session according to an embodiment.

FIG. 6 is a diagram showing a text content with blank spaces, meant for users to insert text into the blanks according to an embodiment.

FIG. 7 is a diagram of a display screen showing content with new pen drawing content added during a collaboration session according to an embodiment.

FIG. 8 is a diagram illustrating a display screen of a user interface for browsing, viewing, and managing content created during a collaboration session, after the session has been completed according to an embodiment.

FIG. 9 is a diagram illustration a display screen of a user interface which is an example of a memorization game, where the content is generated during a collaboration session according to an embodiment.

FIG. 10 is a block diagram illustrating a process flow of online collaboration according to an embodiment.

### DETAILED DESCRIPTION

Embodiments of a method and system for online collaboration enable multiple users to gather content electronic content items from various sources. The content items are associated with a particular user and with each other. Users can find other users that have similar content or personal information. A collaboration session is hosted between multiple participating users that allows the users to access and modify common content during the same session. Modification includes a user marking or labeling content with a label that includes metadata regarding the content. Information from the session, including modifications, is automatically processed and stored as result data. An example of result data is a flash card created for the purpose of language learning. The result data is accessible by the user later for further use and/or modification.

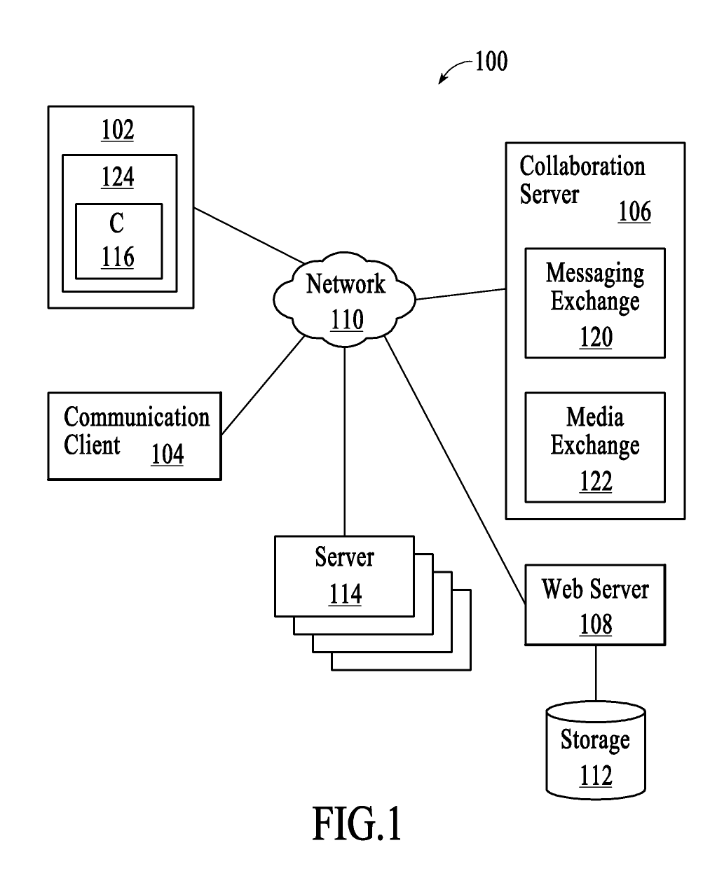

FIG. 1 is a block diagram of a collaboration system 100 according to an embodiment. The system 100 can be used for collaboration around content. The system 100 includes at least one device 102 for viewing and interacting with content, a communication client 104 for audio and video communication, a collaboration server 106 for managing and distributing the communication to and from device 102 and communication client 104, a webserver 108 for displaying content on device 102, a storage device 112 for storing content, and one or more server devices 114. These components of the system 100 can communicate through a computer network 110. The computer network 110 can be the Internet, an internal LAN, or any other computer or communications network. The system allows integration with any other networks and devices such as mobile phones and PDAs. The system 100 can be integrated and rebranded into any other website as a “whitelabel” application. Furthermore the system 100 can be accessed and information can be shared through third party applications such as Facebook™ and its application platform among others. In some implementations, other configurations can be used, including some that do not have a client-server architecture.

In some implementations, the device 102 can include a display for presenting software applications such as web browsers. In some implementations the device 102 can be a computing device such as a desktop computer, a mobile phone, an internet terminal or any other computing device. In other implementations, the device 102 can be a non-computing device such as a television or a digital billboard. Any device with capabilities for viewing content can be included in the system 100. For example, the device 102 can be a desktop computer configured with a web browsing software application for viewing web pages such as an illustrated web page 124.

The web page 124 is a resource of information that can be accessed through an application such as a web browser. In some implementations, a web page may be retrieved from a local computer or from a remote server, such as the server device 108. For example, web pages can include content such as text, pictures, videos, flash animations, presentations, Microsoft PowerPoint™ widgets, advertisements, and other content sourced from one or more server devices 114. The content of web page 124 can be automatically and dynamically adjusted to the type of user who is visiting the site. For example, if the system 100 has knowledge about the user through profile, cookie or other information that the user is a “14 year old student” or a “45 year old investment banker” the design, features and functionalities rendered to that user might vary according to the users segment and previous behavior.

The communication client 104 is used for voice communication and recording audio and playing back audio and video. In some implementations, the communication client 104 is a phone, a mobile phone, PDA, or any physical device that can be used for audio communication. In other implementations, the communication client 14 is a software application that can be executing on any computing device, such as the device 102 or the server devices 114. In some implementations, the software application can be a separate application, such as soft phone, a video phone, communicator, or an audio enabled Instant Messaging application. Examples of these include Skype™, Jajah™, Google Talk™, Yahoo Instant Messenger™, Microsoft Communicator™, and MSN Messenger™. In other applications, the software application is embedded in another software application. Examples of this include widgets in a web browser or the communication part of a collaboration application.

The collaboration server 106 can be configured to manage the information related to users. In some implementations, this information include general types of information such as first name, last name, email address, password, pictures, videos, interests, age, gender, hobbies, a description of background, educational history, and work history. In other implementations, the user information can include information related to education, such as number of languages spoken, skill level in each language, educational background, number of students, and number of learning sessions. In other implementations, the user information can also include information related to communication and collaboration, such as the number of minutes collaborated, number of collaboration sessions, ratings and text describing opinions about the user, and times and dates of the collaboration sessions.

The collaboration server 106 can also be used to manage groups of users. In some implementations, this includes information describing the relationship between users. For example, friendship between users, common interests, memberships of groups, and what other users a user does not want to communicate with. In other implementations, the user group information includes information generated during a collaboration session, such as text, pictures, videos, drawings, recorded audio, recorded video, scripts, templates, session duration, session date, session participants, mouse clicks, mouse movements, cursor movements, and software application interactions. In some implementations, the collaboration server 106 can be configured as a physical server, a software application running on another server or combinations thereof.

Collaboration server 106 further includes a user interface 107 that allows users to interact with the collaboration server and with each other as further described below.

The collaboration server includes a messaging exchange 120. In some implementations, the messaging exchange 120 is used to distribute messages to and from device 102, to and from communication client 104, or to and from a combination of both. In yet other implementations, the messaging exchange 120 can receive information from one or more devices 102, communication clients 104, and server devices 114. In some implementations, the messaging exchange 120 can send information to one or more devices 102, communication clients 104, and server devices 114. In some implementations, the messaging exchange 120 can be configured as a physical server, a software application running on another server such as the collaboration server 106 or server devices 114, or combinations thereof. In some implementations, the message exchange 120 can be an Instant Messaging server, such as Jabber, Skype™, Jajah™, Google Talk™, Yahoo Instant Messaging™ service, Microsoft Messenger™, MSN Messenger™, and Microsoft Communication™ server. In some implementations, the messages may be received and sent from the messaging exchange 120 can use the XMPP protocol. In other implementations, other protocols such as SIMPLE can be used.

The collaboration server 106 can also include a media exchange 122, which is used to manage, receive and send media to and from one or more communication clients 104, allowing users of communication clients 104 to communicate. In some implementations, media can include audio, video, text, images, pictures, and drawings. In some implementations, the media exchange 122 is a local phone system or a global phone company's network. In other implementations, the media exchange 122 is a video conferencing system. In some implementations, the media exchange 122 can be configured as a physical server, a software application running on another server such as the collaboration server 106 or server devices 114, or combinations thereof.

The web server 108 can be configured to manage content for viewing and collaboration. In some implementations, the content managed by the user can be viewed as part of a web page 112 viewable on the device 102. As an example, the content viewed can include text, pictures, images, videos, Flash animations, widgets, Gadgets, presentations, Microsoft PowerPoint™, applications, html-formatted text, and advertisements. In some implementations, the web server 108 can be configured as a physical server, a software application running on another server or combinations thereof. In some implementations, the content managed by the web server 108 can be created by one or more users using the web server 108. In other implementations, the content can be created by one or more users using the device 102. In yet other implementations, the content may have been created using other means system 100 and stored on one or more server devices 114. In another implementation, the content may be stored on storage device 112.

It is significant that content c 116 represents content that is created during a collaboration session. As an example, the user may use the web page 124 to create the content. This content c 116 can be saved on any server device 114, storage device 112, or web server 108. It is likewise significant that the content can be viewed, modified, and managed after the collaboration session. In some implementations, this can be done using device 102 or communication client 104. In other implementations, this is done on at least one server devices 114 or on webserver 108.

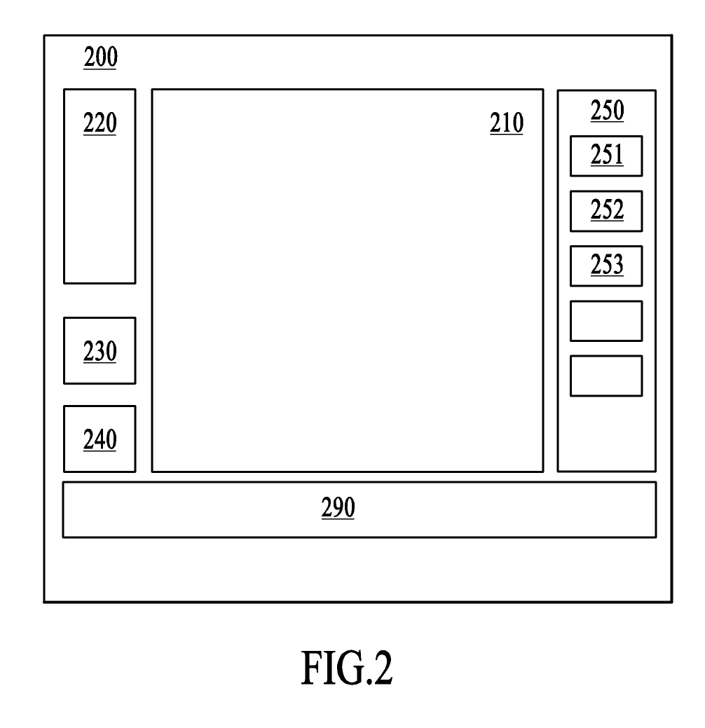

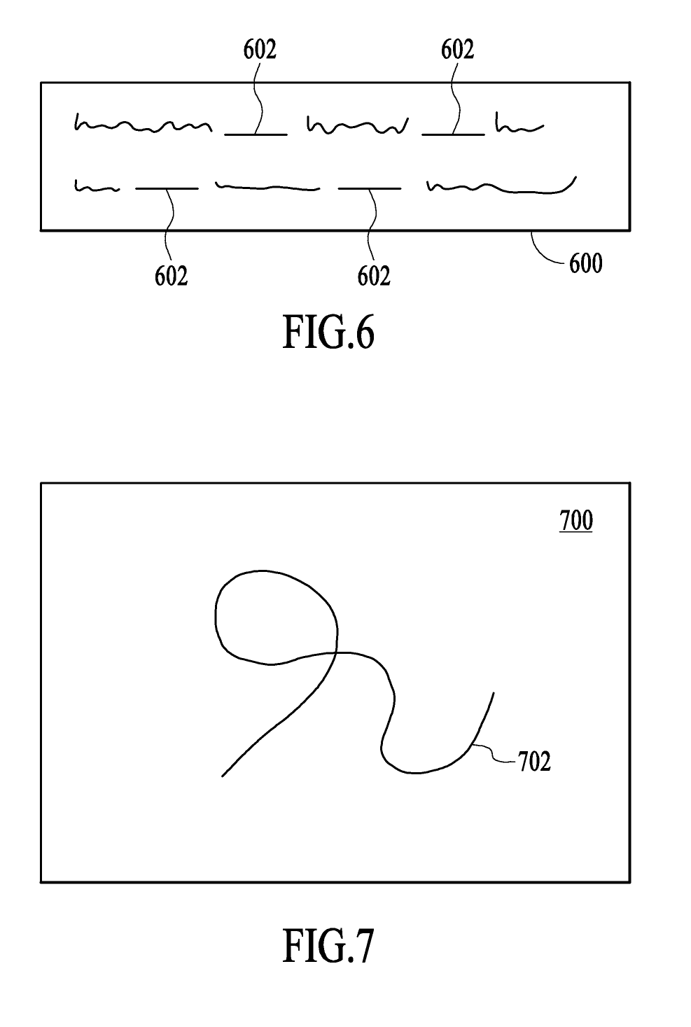

FIG. 2 is a diagram of a collaboration user interface screen 200 according to an embodiment. The user interface screen 200 is an implementation of a collaboration session user interface such as the interface 107. The interface allows users to share and collaborate through data and voice. The overall functionality allows users to create content associated with other content. The arrangement of different interface components can be achieved in any different way. Shared content such as images, videos, etc. is conducted through screen field 210. Screen field 220 may show an overview of all content available and is set up as a navigation device. Screen field 230 is used to allow integration with any other communications tool such as instant messaging and Wikis and such. Screen field 240 is used to show all participants of session. Screen field 250 is used to give access to all communication and content manipulation tools. As an example, filed 250 could represent the access point to functionalities described below, for example with reference to FIG. 4 and FIG. 6. Screen field 252 allows a user to point to a part of the content, such as a picture, in real time so that the action can be viewed by all participants at the same time. Screen field 253 and an indeterminate number of additional fields (not specifically labeled) can provide the user access to additional functions, such as drawing, white-boarding, typing, recording or any other activity that helps to describe content or collaborate. Contextual matching of external content, as displayed in a screen field 290, such as commercial messages, advertising, lead generation mechanisms and such is achieved through mining of all content made available through the system 100 described as well as external online user usage data such as cookies. The combination of asynchronously accumulated data as well as meta-data as well as data collected during synchronous sessions in real time allows embodiments of the system to present appropriate additional messages and content of commercial and non-commercial nature.

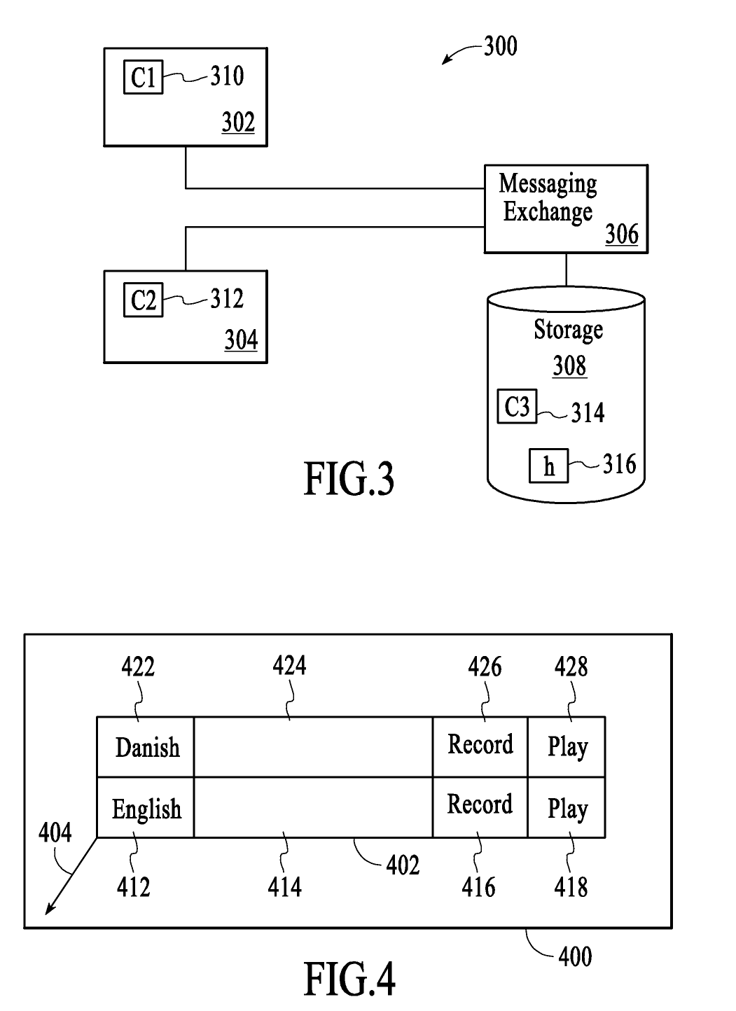

FIG. 3 is a diagram of system components 300, including a messaging exchange with associated devices and storage according to an embodiment. Components 300 participate in generating content and capturing content during a synchronous collaboration session. Devices 302 and 304 are coupled to a messaging exchange 306, which in turn is coupled to a storage device 308. In an embodiment, devices 302 and 304 are embodiments of device 102 of FIG. 1, and messaging exchange 306 is an embodiment of messaging exchange 120 of FIG. 1. Similarly, in an embodiment, storage device 308 corresponds to storage device 112 of FIG. 1.

Through various mechanisms described with reference to FIG. 2, the user can create and modify content c1 312. Any modification made to content c1 (including its first-time creation) is communicated as a message to the device 304 via the messaging exchange 306. Upon receipt of the message, the device 304 will create/modify content c2 312 to reflect the changes described in the message. As a result, the c2 will reflect the change made to c1. Typically, c2 is not identical to c1 at all times. In some implementations, the messages from device 302 may take some time to reach device 304. During the period of time when the message is in transit, the modification made to c1 will not yet have been made to c2. Even further, in some cases device 304 may never receive the message, making c1 and c2 different.

The messaging exchange 306 may create a copy of messages that are sent from device 302 to device 304. In some implementations, messages can be saved in one or more history files h 316 in storage device 308. In some implementations, history files h 316 are simple files on a file system, where messages have been appended. In other implementations, history files h 316 can be one or more data basis or data storage systems. In yet other implementations, a separate content c3 314 may be created from the messages from device 302, similar to the manner in which device 304 creates the content c2 312. As an optimization, this avoids having to recreate content each time it is needed.

In some implementations, not all messages are stored in the history files h 316. In other implementations, the messaging exchange 306 is configurable, including configuring what messages are stored in the history file h 316. In other implementations, only messages from each collaboration session are stored together in one history file h 316. This allows for accurate recreation of content. In other implementations, the messages are stored in separate parts of the history file h 316 but still all in the same file. For example, in cases where the history file h 316 is implemented by a database, messages may be stored in separate rows in the database.

Messages can have extra information associated with them, such as date and time of creation, the order number, an identifier of the user that caused the message to be sent, an identifier of the sending device 302, an identifier of all intended receiving devices 304, a session identifier, a sequence number that identifies the order in which the message was created during the collaboration session, a unique message identifier, and any other information that device 302 adds as extra information. In some implementations, this information is used to regenerate content c2 312 in device 304.

Any type of content can be created during a collaboration session, including text, images, drawings, feeds, web pages, Flash animations, pictures, sounds, videos, sound recordings, video recordings, presentations, Microsoft PowerPoint™, or combinations thereof. Many types of modifications can be made to content. Modifications to text content include deletion, insertion, appending new text, moving text around, changing the layout, etc., but embodiments are not so limited. In a similar fashion, modifications to images may include drawing on top of images, removing parts, adding new parts, overlaying new content, and changing graphics properties. Also, there is no restriction on where the content during a collaboration session is created. Content can be created by users or created by software applications or by some other means. Content can also be created in another system and uploaded into the system using device 302, server devices 308, or using some other means.

In some implementations, modifications to the content can include recording audio or video from the participants in the collaboration session and associating it/attaching it to the content. In such implementations, the recorded audio or video can be stored anywhere, including on storage device 308 and server devices 108. The recorded audio and/or video can be played back to the participants during the collaboration session or after the collaboration session has been completed.

FIG. 4 is a diagram illustrating an example of a piece of structured content 400 that can be generated during a language learning collaboration session according to an embodiment.

In an embodiment, content 400 includes a label that can be generated by users, for example during a language learning collaboration session. Content 400 can be created in synchronous or asynchronous events. As part of the collaboration session, the label 402 is created and associated with content 400. Content 400 can be content generated in advance of the collaboration session, such as a picture, video, article or any other media. Label 402 is useful for recording phrases in a language and then adding the translated word or phrases in a second language. Seeing the phrases in two different languages right next to each other can be helpful to a student of language. The original phrases can be entered by any participant in the collaboration session (such as the student or the teacher). It can also be derived from content 400 or any other content stored elsewhere. In some implementations it may be generated from spoken language using a transcription component and then inserted into the text field after transcription. The translated phrase can likewise be created by one of the participants or derived from content or transcription. In other implementations the same mechanism or technique can be used for any other structured and unstructured content unrelated to language learning. For example, in health care, the same mechanism could be used to describe X-rays images by multiple parties with multiple media inputs such as recordings, video, comparative images and such. In yet another application, the same mechanism or technique could be used for collaboration documents that require multi-media, multi-party input. For example, in a planning exercise a group of travelers in multiple locations are planning a trip online. In this case the travelers can share data and voice in a synchronous and asynchronous way sharing maps, pictures, lists and such sourced from the world wide web or from proprietary sources all in one interface. In yet another application, students can have similar sessions collaborating on homework, or real estate agents can walk clients through virtual homes, videos and other media. All of the collaboratively created materials can be reviewed, shared and altered before and after the synchronous sessions or asynchronous activities.

The label 402 in some implementations can include record buttons 416 and 426, and play buttons 418 and 428. Any participant can click on record buttons 416 and 426 to record the pronunciation of one or both of the phrases. A participant can also click on play buttons 426 and 428 to play back the recording that was made previously. If no recording was previously made, the system can play back external recordings of the phrase. In some implementations, the recording may be a generated by automated text-to-speech systems or from human voices recorded in advance or in real-time.

In some implementations, the label 402 can have a pointer 404 associated with it. The pointer 404 points to an area of content, such as a section of a photo or a word of text. This provides an association between the label and an area of the content. In other implementations, the timing of the modifications to the labels are recorded and associated with the labels. This allows the participants to review each of the modifications by themselves, in order to improve the understanding.

By creating labels during language learning collaboration sessions, the participant users are creating structured pieces of content that combine contents from different languages and allow the user to understand the meeting of phrases in one language through other content.

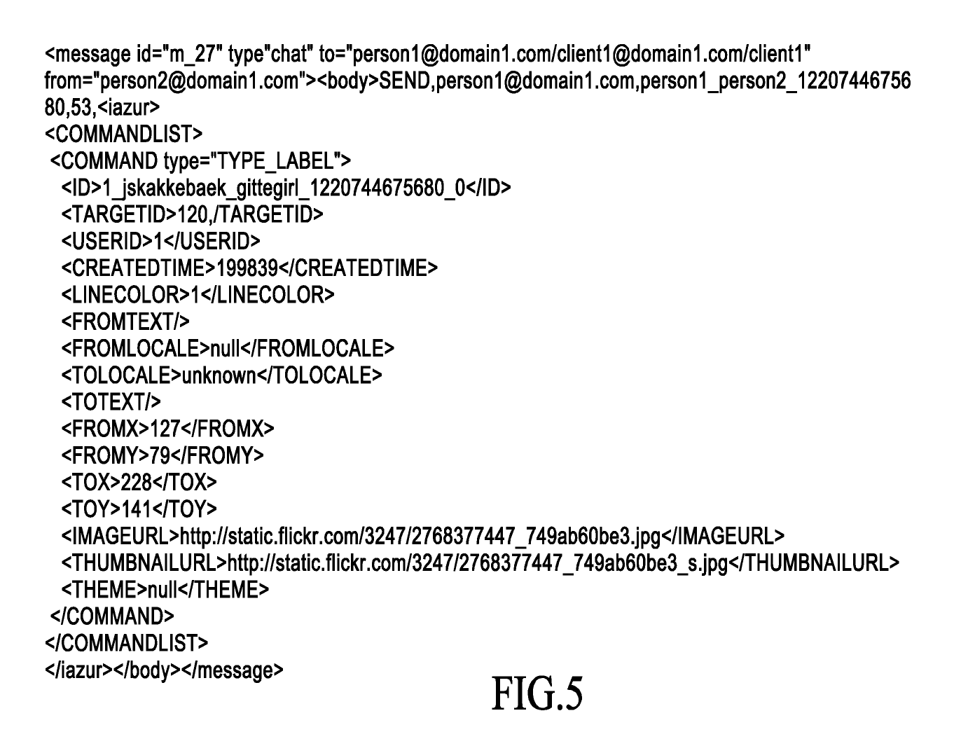

FIG. 5 is a diagram illustrating an example of a content creation message that is used to communicate between devices during a collaboration session according to an embodiment. illustrates one embodiment of a message, as used in the description of FIG. 3 above. The message is sent from the device of person1 to the device of person2, using the XMPP protocol leveraging Instant Messaging. The <body> field contains the actual message describing how to create new content to the existing content during a collaboration session. All other fields are used by the Instant Messaging server to transmit the message between the user devices.

FIG. 6 is a diagram showing a text content with blank spaces, meant for users to insert text into the blanks according to an embodiment. This is another example of content generated from an online language learning collaboration session. The text 600 has a number of blanks 602. The text 600 can be generated before the language learning collaboration session. During the collaboration session, the participants fill out the blanks with new text during the session.

FIG. 7 is a diagram of a display screen showing content with new pen drawing content added during a collaboration session according to an embodiment. By using capabilities provided during the language session, content 702 has been created as a pen drawing, on top of the content 700. As an example, content 702 can be used to highlight features of content 700 that require special attention by the other participants in the session.

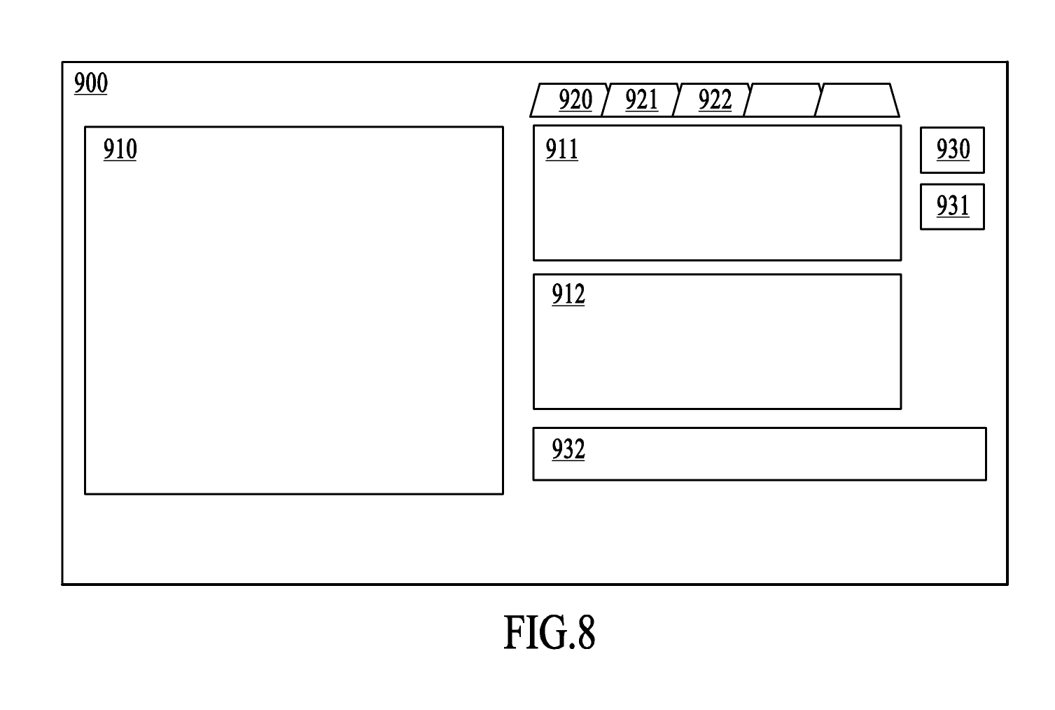

FIG. 8 is a diagram illustrating a display screen of a user interface for browsing, viewing, and managing content created during a collaboration session, after the session has been completed according to an embodiment. FIG. 8 illustrates using the content in individual interactive review activities comparable to flash cards with interface 900. Functionality 910 shows content elements such as pictures, video, etc. that has been used in synchronous sessions or asynchronous collaboration activities. Interface 900 uses all information and content that has been created described in FIG. 4 and FIG. 6 as well as other potentially available data. The interface shows markings where additional meta-information described with reference to FIGS. 4 and 6 have been added. By clicking on those markings, the previously generated content can be reviewed. Tabs 920, 921, 922 allow the user to access functionalities that reflect the capability to sort different content elements according to for example the learning progress. For example, content that has been completely understood can be moved from the first section marked by tab 920 to the next section marked by tab 921. Sections 911 and 912 provide the information that has been developed that has been described in FIG. 4. A section 911 shows one part of the information (as a video, picture or text, for example) and a section 912 is provided for the user to type in the missing content, in case of the language learning application, the translation of the other language. An algorithm allows automatic presentation of errors and prompts the user to correct the input. A section 930 allows to the user to click in order to play and/or edit previously recorded voice or media as part of the functionality described in FIG. 4. A section 932 is used to present standard navigation features such as forward, reverse, see all content and such. Any individual 900 interface or content thereof can either be privately used or shared with other users of the system 100 described with reference to FIG. 1.

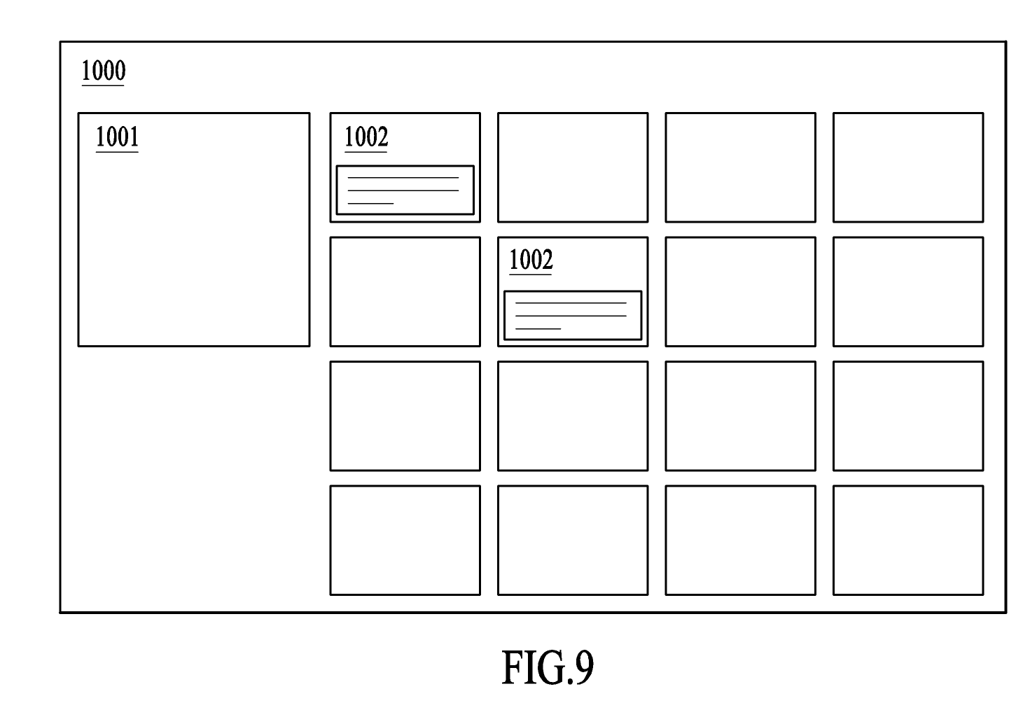

FIG. 9 is a diagram illustration a display screen of a user interface which is an example of a memorization game, where the content is generated during a collaboration session according to an embodiment. FIG. 9 illustrates using the content in shared (community) activities such as memorization games using content that has been or is being created through system 100 by users. Two or more users play against each-other. The reader skilled in the art will appreciate that many variations of entertainment like games that the user can engage with in private, such as described in FIG. 8, or in a shared environment is very broad. Similar to the description in FIG. 8, interface 1000 uses all information and content that has been created as described with reference to FIGS. 4 and 6, as well as other potentially available data. An area 1001 is used to shows users currently associated with the activity or game, as well as scores and other ranking metrics and statistics in form of detailed views and dashboards. An area 1003 is used to allow the users to electronically see front and back-page of electronic cards that hold the content created as described in FIG. 4. There are always two matching cards that the user can uncover in order to deepen his/her learning skills. The functionality display pieces lying face down. A user gets to pick two cards, both of which will be revealed to everybody. If the two cards match, the user gets to remove the cards from the game board and receives a point that is displayed in 1001. An algorithm places all electronically available cards randomly so that activity can be repeated without a known pattern. Content in shared activities are provided from the system described with reference to FIG. 1, across multiple associated users.

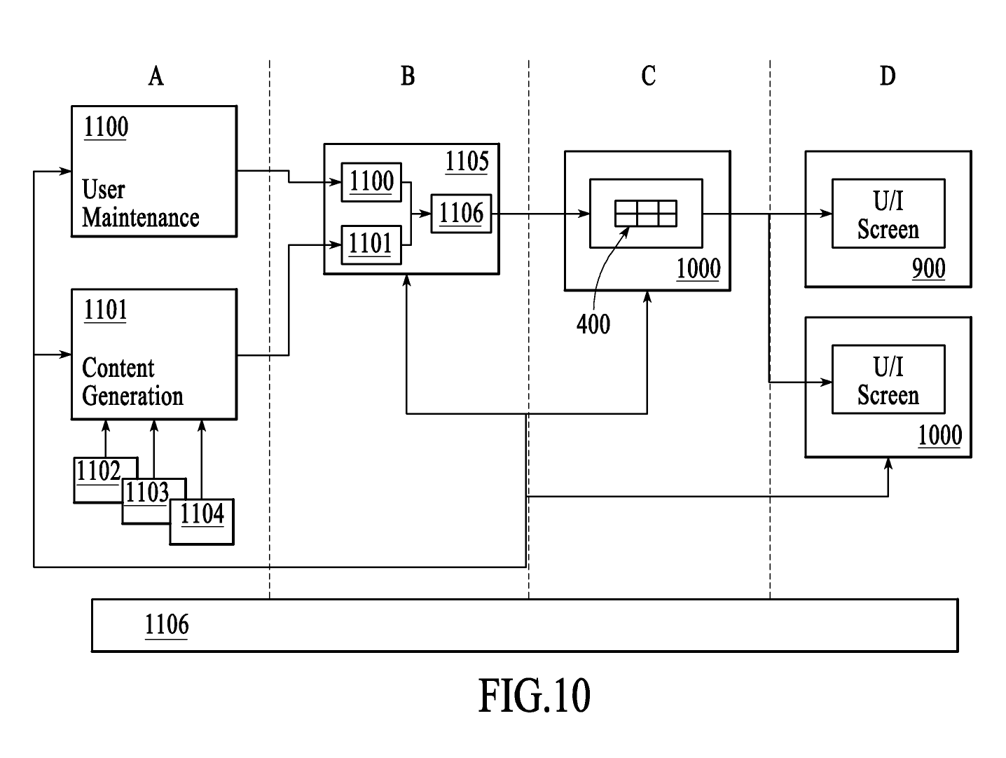

FIG. 10 is a process diagram that summarizes an example use case of the system 100 in an embodiment. The use case is illustrated as a process with four phases, A, B, C, and D. In phase A, a user maintenance module 1100 allows the user to view and maintain his account and profile using a web browser. A content generation module 1101 allows the user to generate initial content including still or moving images, text, or other data. The user is enabled to use available APIs to connect to other services such as 1102 flickr™, 1103 YouTube™ or any other third party content providers. The user can also make proprietary content from his own hard-drive 1104 or other storage device accessible. The used media content can be enhanced through additional text or other data within the functionality made accessible though modules 1100 and 1101 in phase B.

A collaboration module 1105 allows the user to see which other users are available online and offline and what content they have to share or collaborate about. A communication module 1106 allows the user to instantly connect through different means of communication such as VOIP, Instant Messaging, eMail, and to a desired fellow user either through the selection of desired content or a particular user profile. The process includes a message that is sent from the communication initiator to the communication receiver that allows the receiver to either accept or reject the request.

In phase C, after the request to communicate is accepted functionalities described in FIG. 2 are applied. During the synchronous sessions functionalities described with reference to FIG. 4 may or may not be used. Users may rate content and/or other users based on their experience during the session. Ratings are stored and accessible to users. Ratings are updated using an algorithm that computes overall ratings for users and content when new ratings are submitted.

In phase D, after the session is completed functionalities described with reference to FIGS. 8 and 9 are applied.

During the whole process of collaboration in steps all of the phases A-D, behavioral and contextual data is captured and can be used for analytics and commercial or non-commercial outputs such as advertising or further use recommendations.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. An online collaboration method, comprising:
gathering first content from a plurality of sources as specified by a first user, wherein the first content comprises a plurality of data items in a plurality of electronic formats;
associating the plurality of data items of the first content with each other and with the user;
receiving a request from the first user to identify at least one second user based on similarities between the first content and a second content associated with the at least one second user, wherein the second content comprises a plurality of data items in a plurality of electronic formats;
during an online collaboration session between the first user and the at least one second user, associating the first content with the second content; and
automatically processing the data of the online collaboration session to create a set of result data, wherein the result data includes third content comprising first content data items, second content data items, and metadata related to the third content, wherein the result data is useable to display the third content, to use the third content, to modify the third content, and to manage the third content.

2. The method of claim 1, further comprising presenting a user interface to each of the first user and the at least on second user during the collaboration session, wherein the user interface allows a user to access the first content in real time, to access the second content in real time, to modify the first content in real time, and to modify the second content in real time.

3. The method of claim 2, wherein modifying comprises attaching labels to content displayed on a display device, wherein a label is configurable by a user, and the label is associated with the content.

4. The method of claim 3, wherein the content is an image displayed on the display device, and wherein a location of the label affects the association of the label with the content.

5. The method of claim 4, wherein the third content comprises the label.

6. The method of claim 5, wherein the third content comprises the label presented as an interactive flash card with which the user interacts in a learning session.

7. The method of claim 6, further comprising using results of the learning session to modify the flashcards in real time.

8. The method of claim 1, further comprising receiving a request from a user to access the result data, wherein accessing comprises the user interacting with the third content.
